(19) United States
(12) Patent Application Publication
(10) Pub. No.: US 2014/0202774 A1
(43) Pub. Date: Jul. 24, 2014

(54) Wear Element for Downhole Tool with a Cold-Pressed Graphite Wear Layer

(71) Applicant: Ulterra Drilling Technologies, L.P., Fort Worth, TX (US)

(72) Inventors: Neal Alan Bowden, Mansfield, TX (US); William Henry DuBose, Irving, TX (US); Thomas Alan Damian, Denver, CO (US)

(21) Appl. No.: 14/160,395

(22) Filed: Jan. 21, 2014

Related U.S. Application Data
(60) Provisional application No. 61/754,963, filed on Jan. 21, 2013.

(51) Int. Cl. E21B 10/567; B24D 18/00; B32B 9/04

(52) U.S. Cl. CPC E21B 10/567; B32B 9/04; B24D 18/0009
USPC 175/432; 51/307; 51/309

(57) ABSTRACT

A wear element for a downhole, earth cutting tool for forming bore holes comprises a wear layer made of “cold pressed graphite” attached to a substrate comprised of, for example, a cemented metal carbide. Cold pressed graphite is, depending on the arrangement of carbon bonds, also referred to as M-carbon or W-carbon, cbt-c4, Z-Carbon and others. The wear element is formed by pressing with a previously formed cemented carbide substrate particles of one or more carbon allotropes, including, for example, SP2 bonded carbon allotropes, such as Fullerenes, carbon nanotubes, graphite, at pressures in excess of 1,000,000 pounds per square inch, or 6.89 Gigapascals, at a temperature substantially below 600 degrees Celsius.

### CROSS-REFERENCE TO RELATED APPLICATION

This application claims the benefit of U.S. provisional application No. 61/754,963, filed Jan. 21, 2013, entitled, “Wear Element for Downhole Tool with a Cold-Pressed Graphite Wear Layer,” which is incorporated herein in its entirety by reference for all purposes.

### BACKGROUND

There are several types of tools used to bore through, and to otherwise form bore holes in, subterranean rock formations when drilling oil and natural gas wells: drag bits and roller cone bits. Examples include rotary drag bits, roller cone bits, and reamers.

Drag bits have no moving parts. As a drag bit is rotated, typically by rotating a drill string to which it is attached, discrete cutting elements (“cutters”) affixed to the face of the bit drag across the bottom of the well, scraping or shearing the formation. Each cutter of a rotary drag bit is positioned and oriented on a face of the drag bit so that a portion of it, which will be referred to as its wear surface, engages the earth formation as the bit is being rotated. The cutters are spaced apart on an exterior cutting surface or face of the body of a drill bit in a fixed, predetermined pattern. The cutters are typically arrayed along each of several blades, which are raised ridges extending generally radially from the central axis of the bit, toward the periphery of the face. When the tool is rotated, its cutters to fracture the formation through a shearing action, resulting in formation of small chips that are then evacuated hydraulically by drilling fluid pumped through carefully placed nozzles in the body of the tool.

Roller cone bits are comprised of one or more cone-shaped cutters that rotate on an axis at approximately thirty-five degree angle to the axis of rotation of the drill bit. As the bit is rotated, the cones roll across the bottom of the hole. Cutting elements—also called cutters—on the surfaces of the cones crush the rock as they pass between the cones and the formation.

In order to improve performance cutters and the earth boring tools on which they are mounted, one or more wear or working surfaces of the cutting elements are made from a layer of sintered polycrystalline diamond (“PCD”), polycrystalline cubic boron nitride, wurtzite boron nitride, aggregated diamond nanotubes (ADN) or other hard, crystalline materials. The layer, usually made in the form of compact, is attached to a substrate typically made, at least in part, from cemented metal carbide, with tungsten carbide being the most common. Cemented metal carbide substrates are formed by sintering powdered metal carbide with a metal alloy binder.

The composite of a polycrystalline diamond compact (“PDC”) and the substrate can be fabricated in a number of different ways. It may also, for example, include transitional layers in which the metal carbide and diamond are mixed with other elements for improving bonding and reducing stress between the PCD and substrate. Each cutter is fabricated as a discrete piece, separate from the drill bit. Fixed cutters are mounted on an exterior of the body of an earth boring tool in a predetermined pattern or layout.

For a so-called “PDC bit”, which is rotary drag bit with PDC cutters, the cutters are typically arrayed along each of several blades, which are comprised of raised ridges formed on the body of the earth boring tool. In a PDC bit, for example, blades are generally arrayed in a radial fashion around the center axis (axis of rotation) of the bit. The length or height of the substrate is typically long enough to act as a mounting stud, with a portion of it fitting into a pocket or recess formed in the body of the drag bit or, in the case of a roller cone bit, the pocket formed in a cutter.

A polycrystalline diamond compact is made with polycrystalline diamond grains, in powder form, which is referred to as “diamond grit,” with the possible addition of one or more powdered metal catalysts and other materials, forming the mixture into a compact, and then sintering it using high heat and pressure or microwave heating. Although cobalt or an alloy of cobalt is the most common catalyst, other Group VIII metal, such as nickel, iron and alloys thereof can be used as catalyst. For a cutter, a PDC is typically formed by packing diamond grit without the metal catalyst adjacent a substrate of cemented tungsten carbide, and then sintering the two together. Sintering typically takes place at pressure of less than 1,000,000 pounds per square inch and at temperatures between 1300 degrees Celsius and 1500 degrees Celsius. During sintering, metal binder in the substrate—cobalt in the case of cobalt cemented tungsten carbide—sweeps into and infiltrates the compact, acting as a catalyst to cause formation of diamond-to-diamond bonds between adjacent diamond grains. The result is a mass of bonded diamond crystals, which has been described as continuous or integral matrix of diamond and even a “lattice,” having interstitial voids between the diamond. The interstitial voids are at least partly filled with the metal catalyst. Polycrystalline cubic boron nitride, wurtzite boron nitride, aggregated diamond nanotubes (ADN) or other hard, crystalline materials can be substituted for polycrystalline diamond. It may also, for example, include transitional layers in which the metal carbide and diamond are mixed with other elements for improving bonding and reducing stress between the PDC and substrate. Such layers, if they are present, will be treated as being part of the substrate for purposes of the following description.

Because of the presence of metal catalyst, PDC exhibits thermal instability. Any metal catalyst will have a different coefficient of expansion to diamond. It expands at a greater rate, thus tending to weaken the diamond structure at higher temperatures. Furthermore, the melting point of the metal catalyst is lower than diamond, which can lead to the metal catalyst causing diamond crystals within the PDC to begin to graphitize when temperatures reach or exceed the melting point, also weakening the PDC. To make the PDC at least more thermally stable, a substantial percentage—usually more than 50%; often 70% to 85%; and possibly more—of the catalyst is removed from at least a region next to one or more working surfaces that experience the highest temperatures due to friction. The working surfaces are often defined as the surfaces of the cutter designed or intended for engaging the formation. In the case of a PDC cutter, for example, they are typically the top surface of the diamond crown or table, at least part of its side surface, and, if present, a beveled edge, radiused or shaped transition between the top and side surfaces.

Removal of the catalyst is, however, thought to reduce toughness of the PCD, thus decreasing the cutter's impact resistance. Furthermore, leaching the PCD can result in removal of some of the catalyst metal that cements or binds the substrate, thus affecting the strength or integrity of the substrate and/or the interface of the substrate and diamond interface.

### SUMMARY

The invention pertains generally to a wear element for a downhole, earth cutting tool for forming bore holes, comprising a wear layer made of superhard carbon allotropes. Superhard carbon allotropes are sometimes referred to as cold-pressed graphite, and include M-carbon, W-carbon, Z-carbon, cbt-C4 and oC16-II depending on the arrangement of carbon and the bonds between the carbon atoms. The superhard carbon allotropes feature SP2 and/or SP3 bonds, and are formed, as the name suggests, at relative low (“cold”) temperatures but at very high pressures, typically in excess of 10 Gigapascals (GPa).

In one embodiment of an exemplary wear element for an earth cutting tool, one or more layers of superhard carbon allotrope, or cold pressed graphite, is attached to a substrate comprised of, for example, a cemented metal carbide. The substrate of the wear element is brazed, mechanically fastened, or otherwise attached to a body of a downhole tool.

In another illustrative embodiment of a wear element for a downhole tool, cold pressed graphite is formed by pressing, with a previously formed cemented carbide substrate, particles of one or more carbon allotropes at pressures in excess of 1,000,000 pounds per square inch, or 6.89 GPa, at relatively “cold” temperatures, to form one or more wear layers on the substrate. Cold temperatures are those substantially below 600 degrees Celsius. In one example, one or more carbon allotropes are selected from a class of SP2 bonded carbon allotropes, including, for example, Fullerenes, carbon nanotubes and graphite. In another example, the particles of carbon allotropes are pressed at a pressure in the range of 10 GPa (or 1.4 million pounds per square inch) to 20 GPa to form a superhard carbon allotrope, or, in the alternative, at a pressure of over 20 GPa (or 2.9 million pound per square inch) to form a superhard carbon allotrope, in each case at cold temperatures. In each of the foregoing examples, the particles can be pressed without a catalyst to form a superhard carbon allotrope.

In another illustrative embodiment, one or more wear layers of superhard carbon allotrope are bonded to the substrate by pressing one or more previously formed wear layers of superhard carbon allotrope on a substrate containing a metal binder, at a lower pressure and at a higher temperature than is required to form the cold-pressed graphite, the temperature being sufficient to cause the metal binder in the substrate to wet adjacent surfaces of a layer of cold-pressed graphite, without damaging the cold-pressed graphite or the substrate.

A cutter comprising a wear layer of cold pressed graphite will possess one or more of the following: enhanced mechanical properties; higher abrasion resistance through higher thermal conductivity in a more homogenous structure that is largely devoid of metal catalyst, at least along the working surfaces and edges of the edges of the cutter; and higher impact resistance due to an amorphic lattice structure and reduced cleavage plains.

### BRIEF DESCRIPTION OF THE DRAWINGS

FIG. 1 is a perspective view of a representative example of an earth boring tool in the form of a rotary drag bit.

FIGS. 2A, 2B, and 2C are perspective, side, and top views, respectively, of a representative cutter suitable for the drag bit of FIG. 1.

FIG. 2D is a cross-section of FIG. 2B, taken along section lines 2D-2D.

FIG. 3 is a flow diagram illustrating the basic steps of a representative process for fabricating a cutter or other wear element for a downhole tool.

### DETAILED DESCRIPTION OF EXEMPLARY EMBODIMENTS

In the following description, like numbers refer to like elements.

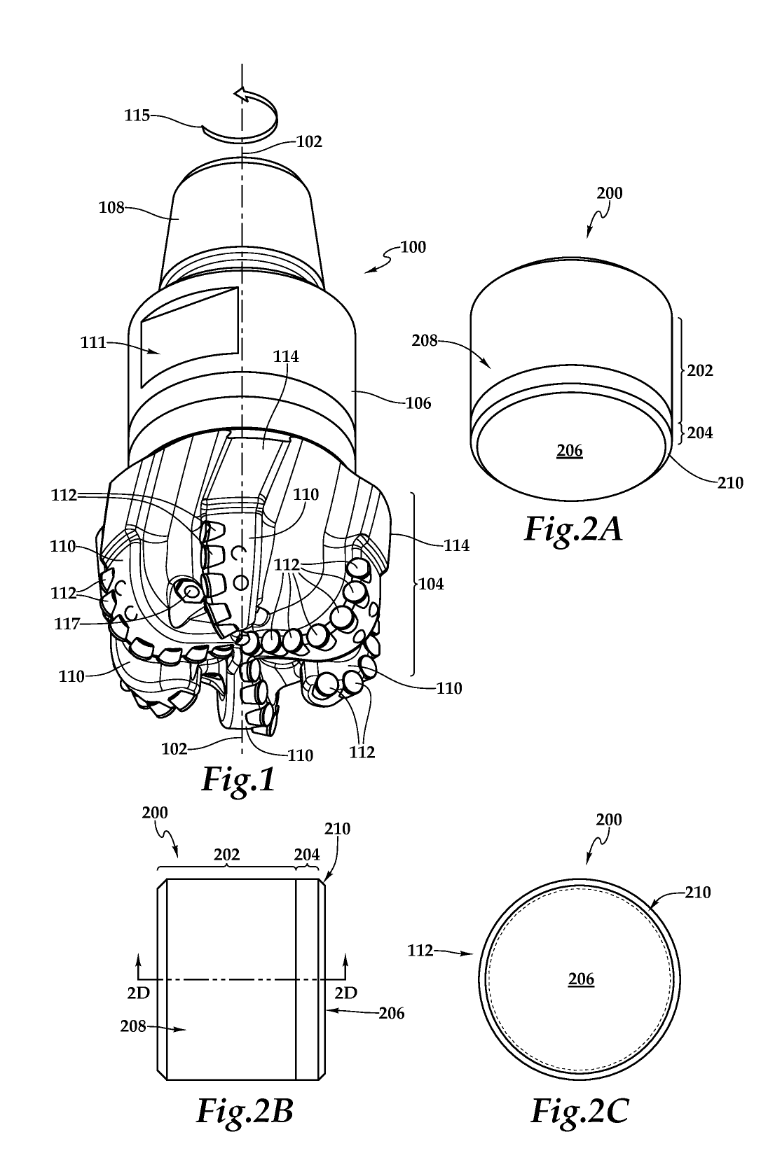

FIG. 1 illustrates a representative, non-limiting example of a downhole tool, namely a rotary drag bit 100. Drag bit 100 is a representative example of drag bits, drill bits for drilling oil and gas wells, and downhole tools for cutting earth formations to form or change bores holes that use or possess wear elements. Intended to be rotated around its central axis 102, it is comprised of a bit body 104 connected to a shank 106 having a tapered threaded coupling 108 for connecting the bit to a drill string and a “bit breaker” surface 111 for cooperating with a bit breaker to tighten and loosen the coupling 108 to the drill string. The exterior surface of the body intended to face generally in the direction of boring is referred to as the face of the bit. The face generally lies in a plane perpendicular to the central axis 102 of the bit. The body is not limited to any particular material. It can be, for example, made of steel or a matrix material such as powdered tungsten carbide cemented by metal binder.

Disposed on the bit face are a plurality of raised “blades,” each designated 110, that rise from the face of the bit. Each blade extends generally in a radial direction, outwardly to the periphery of the cutting face. In this example, there are six blades substantially equally spaced around the central axis and each blade, in this embodiment, sweeps or curves backwardly in relation to the direction of rotation indicated by arrow 115.

On each blade is mounted a plurality of discrete cutting elements, or “cutters,” 112. Each discrete cutting element is disposed within a recess or pocket. In a drag bit the cutters are placed along the forward (in the direction of intended rotation) side of the blades, with their working surfaces facing generally in the forward direction for shearing the earth formation when the bit is rotated about its central axis. In this example, the cutters are arrayed along blades to form a structure cutting or gouging the formation and then pushing the resulting debris into the drilling fluid which exits the drill bit through the nozzles 117. The drilling fluid in turn transports the debris or cuttings up the bore hole, to the surface.

In this example of a drag bit, all of the cutters 112 are comprised of substrate bonded or otherwise attached to a wear layer comprising cold-pressed graphite. This example of a drill bit includes gauge pads 114.

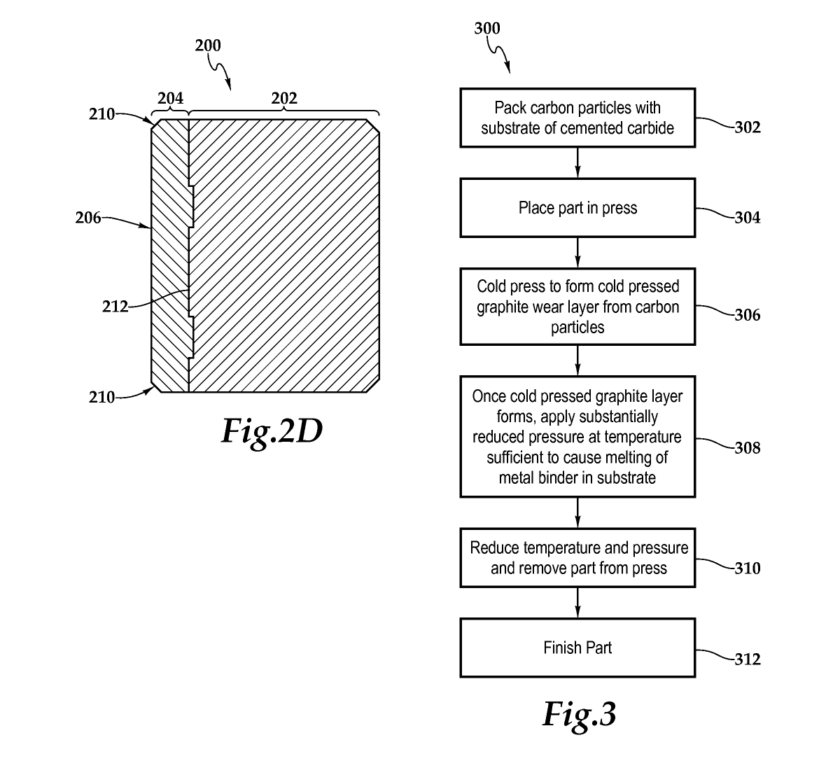

FIGS. 2A-2D illustrate a representative example 200 of a cutter for an earth boring downhole tool. For example, such a cutter can be used as cutters 112 in the rotary drag bit of FIG. 1. The representative 200 of a cutter is comprised of a substrate 202, on which a wear layer 204 of cold pressed graphite has been formed using a process similar to that described in FIG. 3. Note that the cutter is not drawn to scale. It is intended to be representative of cutters generally that have a wear layer comprised of cold pressed graphite attached to a substrate. Although often cylindrical in shape, such cutters in general are not limited to a particular shape, size, or geometry, or to a single wear layer. Similarly, a wear layer can assume, depending on the application, different shapes and thicknesses. In this illustrative example the wear layer forms a symmetrical “table,” of relatively uniform thickness, that matches the cross-sectional shape of the cylindrical substrate. Although the example of a disc-shaped wear layer as shown has some advantages, at least in certain applications, wear layers need not be limited to such shape. The substrate and wear layer could be made, or cut or milled, in different shapes, and the wear layer can have a non-uniform thickness and complex geometries. Thus, the example illustrated is not intended to be limiting, and the term “layer” should not be interpreted as limiting the structure of the cold pressed graphite to a particular geometry.

In this example, an edge between top surface 206 and side surface 208 of the wear layer 204 is beveled to form a beveled edge 210. The top surface and the beveled surface are, in this example, each a working surface for contacting and cutting through the formation. A portion of the side surface, particularly nearer the top, may also come into contact with the formation or debris. Not all of the cutters on a bit or downhole tool must be of the same size, configuration, or shape. In addition to being sintered with different sizes and shapes, such cutters can be cut, ground, or milled to change their shapes. Furthermore, the cutter could have multiple discrete wear layers. Other examples of possible cutter shapes might be pre-flattened gauge cutters, pointed or scribe cutters, chisel-shaped cutters, and dome inserts.

FIG. 2D is a cross-section taken along section lines 2D-2D of FIG. 2B to show an illustrative example non-planar interface 212 between the substrate 202 and wear layer 204. The interface is not to scale. The illustrated example is comprised of complementary surface features in the form of ridges. However, other different configurations and geometries are possible. The non-planar interface functions to reduce stress between the substrate and wear layer of cold pressed graphite that results from different coefficients of thermal expansion of the two materials. Optionally, the interface between the wear layer and the substrate can be made so that it is planar, or substantially flat.

Cold pressed graphite can take many forms that are neither hexagonal nor cubic diamond. Although it is not yet fully understood, one of the most likely structures to result from cold-pressing graphite currently is a low-enthalpy monoclinic structure called M-carbon (space group C2/m, Z516). It has also been referred to as “superhard graphite.” All carbon atoms in the M-carbon structure are four-coordinate and form 5-membered and 7-membered rings. However, other possible structures for cold pressed graphite have been proposed. All of the candidate structures have distinct topologies featuring different patterns, combining odd (5 and 7) and even (4, 6, and 8) rings. In addition to M-carbon other possible structures for cold pressed graphite include a body-centered tetragonal structure called bct-C4 (space group I/4 mmm, Z58), with four-coordinate carbon atoms forming 4-membered and 8-membered rings on the (001) projection, and W-carbon (space group Pnma, Z516). The structure of W-carbon is very similar to that of M-carbon, featuring 5-membered and 7-membered rings. Still other possible structures are an orthorhombic structure, called oC16-II (Cmmm, Z516) and structures that combine even-membered rings (4, 6, and 8), such as oC16-I, mC12, and mC32. All of these structures possess, in theory, similar physical properties, such as bulk moduli and hardness, and, unless specifically indicated otherwise, should all be considered as cold pressed graphite for purposes of this description.

One method of forming cold pressed graphite comprises pressing particles of one or more carbon allotropes, and subjecting the particles during the pressing to pressures greater than 6.89 GigaPascals (GPa) at the temperatures substantially less than 600 degrees Celsius. Examples of carbon allotropes suitable for pressing to form cold-pressed graphite include SP2 bonded carbon allotropes. SP2 bonded carbon allotropes include graphite, fullerenes, and carbon nanotubes, as well as mixtures of two or more of these, or other suitable, allotropes. More specifically, example embodiments of methods of forming cold pressed graphite comprises pressing particles of an SP2 bonded carbon allotrope, and specifically, for example, graphite, under a pressure not less than 6.89 GPa, and, depending on the allotrope, at pressures of greater than 10 GPa (for example at pressures between 15 and 19 GPa), and at pressures greater than 20 GPa, and at ambient temperatures or at temperatures between 0 and 200 degrees Celsius. Unless otherwise specified, cold pressing will refer to a process of applying to particles of one or more carbon allotropes, using a press, pressures greater 1,000,000 pounds per square inch, which is approximately 6.89 GPa, at temperatures of substantially less than 600 degrees Celsius to form cold pressed graphite. At temperatures of 600 degrees Celsius or higher, Lonsdalite will tend to form.

FIG. 3 illustrates a representative process 300 for forming cutter 200 or other wear element, having a substrate and a wear layer or structure attached to the substrate, the wear layer comprising, or consisting essentially of, cold-pressed graphite. At step 302 particles of a carbon allotrope are packed and held against one or more predetermined surfaces of a substrate most often comprising a cemented carbide, such as cemented tungsten carbide, which has been previously sintered and formed into a substrate with the desired dimensions and surface characteristics. The resulting part is placed in a suitable press at step 304 and subjected to a cold pressing at step 306, during which pressure greater than 6.89 GPa (or 1,000,000 pounds per square inch) is applied to the part, while the temperature of the part remains less than 600 degrees Celsius. In one example, the temperature of the part during pressing is not greater than 28 degrees Celsius. In another embodiment, pressing occurs at ambient temperature. In yet other examples, the pressure to which the part is subjected is greater than 10 GPa and preferably between 10 GPa and 20 GPa, in one example, and greater than 20 GPa (2,900,000 pounds per square inch), in another example, the pressure depending on the particular superhard carbon allotrope, while the temperature of the part is, for each of these examples, less than 600 degrees Celsius in one embodiment, less than 200 degrees Celsius in another embodiment, equal to or less than 28 degrees Celsius in yet another embodiment, or at ambient temperature in a fourth embodiment.

Once the particles are transformed into a cold pressed carbon allotrope, the process 300 may stop, skip step 308, or continue to the optional step 308. Step 308 can also be performed at a later time, separately from process 300. During step 308, the part is subjected to another or second pressing. The second pressing can be comprised of a second phase, or an extension, of the press cycle started at step 306, where the part is not removed between the pressings. Step 308 may also comprise a second or additional press cycle, which can take place at a later time. During the second pressing, the part is subjected to higher temperatures and lower pressures as compared to the first pressing.

During cold pressing at step 304, since the temperature is well below the melting point of the metal binder, the metal from the substrate does not leave or migrate from the substrate. In the second pressing of step 308, the temperature is raised high enough to cause metal binder in the substrate to melt and wet the cold press carbon along the interface between the two, without damaging either the cold pressed carbon or the substrate. Wetting the surface or surfaces of the cold pressed graphite that contact the substrate improves adhesion, once the part cools, between the wear layer of cold pressed carbon and the substrate. In one example the second pressing occurs, depending on the particular metal binder in the substrate, at a temperature at or above 1300 degrees Celsius, and in another example at or above 495 degrees Celsius. In each example, pressing occurs at substantially lower pressures than cold pressing step, for example, at less than 5 GPa. Once the second pressing finishes, the part is removed from the press at step 310 and finished at step 312. As a final step, the wear part is attached, joined, or fastened to a body of a down hole earth cutting tool, by, for example, brazing, welding or press-fitting it to the body or a part of the body, or to a pocket formed in the body or the part of the body.

Alternatively, the wear layer of cold-pressed graphite may be formed separately from the substrate in the form of, for example, a wafer, cylinder, or other disk shaped element, and then joined, attached or affixed to a cemented carbide substrate. In one embodiment, the cold-pressed graphite wear layer is, if desired, milled, ground or otherwise formed into the desired shape prior to being joined, attached or affixed to the substrate. In another embodiment, it is formed into the desired shape (if not already in the desired shape after being pressed) after it is joined, attached or affixed to the substrate. In one example, the wear layer is joined to the substrate by brazing it, using a brazing alloy, or by welding it to the substrate. In another example, an adhesive joins the wear layer and substrate. In yet another example, it is mechanically joined by means of, for example, a fastener, interfering or interlocking members on the wear layer and substrate, or other mechanical means.

The foregoing description is of exemplary and preferred embodiments. The invention, as defined by the appended claims, is not limited to the described embodiments. Alterations and modifications to the disclosed embodiments may be made without departing from the invention. The meaning of the terms used in this specification are, unless expressly stated otherwise, intended to have ordinary and customary meaning and are not intended to be limited to the details of the illustrated or described structures or embodiments.

What is claimed is:

1. A wear element for a downhole tool, comprising a substrate and at least one wear layer attached to the cemented carbide substrate, the at least one wear layer comprising cold pressed graphite.

2. The wear element of claim 1, wherein the cemented carbide substrate has at least one non-planar surface, to which the at least one wear layer is attached.

3. The wear element of claim 1, wherein the substrate is comprised of a carbide cemented with a metal, and wherein the at least one wear layer is substantially devoid of metal binder from the cemented carbide substrate.

4. The wear element of claim 1, wherein the substrate comprises a carbide cemented with a metal binder, and wherein cold pressed graphite wear layer is bonded to the substrate by metal binder from the substrate along at least a portion of an interface between the cold pressed graphite wear layer and the cemented carbide substrate.

5. The wear element of claim 1, wherein the cold pressed graphite wear layer is attached to the cemented carbide substrate by brazing or welding.

6. The wear element of claim 1, wherein the cold pressed graphite wear layer is attached to the cemented carbide substrate by use of an adhesive.

7. The wear element of any one of claims 1, wherein the method of attachment of the cold pressed graphite wear layer to the cemented carbide substrate is mechanical.

8. The wear element of claim 1, wherein the cold pressed graphite is formed by pressing one or more of SP2 bonded carbon allotropes with a pressure greater than 6.8 GPa, and at a temperature substantially below 600 degrees Celsius.

9. The wear element of claim 8, wherein the temperature is ambient temperature.

10. The wear element of claim 8, wherein the temperature is at or below 28 degrees Celsius.

11. The wear element of claim 8, wherein the one or more SP2 bonded carbon allotropes are pressed at a pressure greater than 10 GPa.

12. The wear element of claim 8, wherein the one or more SP2 bonded carbon allotropes are pressed at a pressure greater than 25 GPa.

13. The wear element of claim 8, wherein the one or more SP2 bonded carbon allotropes are pressed at a pressure greater than 20 GPa.

14. The wear element of claim 8, wherein the pressure is greater than 10 GPa and the temperature is at or below 28 degrees Celsius.

15. The wear element of claim 1, wherein the wear element comprises a cutter for a downhole tool.

16. A method of making a wear element for a downhole tool, comprising:
placing in a press a part comprising a substrate and particles of one or more carbon allotropes packed adjacent to one or more surfaces on the substrate; and
pressing the part at a temperature of substantially less than 600 degrees Celsius, and a pressure of at least 6.8 GPa;
whereby at least one wear layer comprising cold pressed graphite is formed on the one or more surface of the substrate.

17. The method of claim 16, wherein the one or more carbon allotropes are selected from a group consisting of SP2 bonded carbon allotropes.

18. The method of claim 16, wherein the substrate is comprised of a cemented metal carbide.

19. The method of claim 16, wherein the particles consist essentially of graphite.

20. The method of claim 16, wherein the temperature is ambient temperature.

21. The method of claim 16, wherein the temperature is at or below 28 degrees Celsius.

22. The method of claim 16, wherein the pressure is greater than 10 GPa.

23. The method of claim 16, wherein the pressure is greater than 15 GPa.

24. The method of claim 16, wherein the pressure is greater than 20 GPa.

25. The method of claim 16, further comprising, after forming the at least one layer of cold pressed graphite on the substrate, pressing the part at a temperatures greater than 600 degrees Celsius and at a pressure of substantially less than 6.8 GPa to cause metal binder in the substrate to wet at least a portion of an interface between the at least one wear layer of cold pressed graphite and the substrate.

26. The method of claim 25, wherein the metal binder from the substrate does not infiltrate the at least one wear layer of cold pressed graphite.

27. A downhole comprising,
a body; and
a plurality of fixed cutters disposed on the body;
wherein at least one of the plurality of fixed cutters is comprised of a cemented carbide substrate and one or more wear layers attached to the cemented carbide substrate, the one or more wear layers including at least one wear layer comprising cold pressed graphite.

28. The downhole tool of claim 27, wherein the cemented carbide substrate is comprised of a non-planar surface, to which the at least one wear layer comprising cold pressed graphite is attached.

29. The downhole tool of claim 27, wherein the cemented carbide substrate is comprised of a carbide cemented with a metal binder, and wherein the layer of cold pressed graphite is substantially devoid of metal binder from the cemented carbide substrate.

30. The downhole tool of claim 27, wherein the at least one wear layer of cold pressed graphite is bonded to the substrate by a metal binder from the cemented carbide substrate along an interface between the at least one wear layer of cold pressed graphite and the cemented carbide substrate.

31. The downhole tool of claim 27, wherein the at least one layer of cold pressed graphite is formed by pressing one or more of SP2 bonded carbon allotropes at a pressure greater than 6.8 GPa. and at a temperature below 600 degrees Celsius.

32. The downhole tool of claim 27, wherein the temperature is ambient temperature.

33. The downhole tool of claim 27, wherein the temperature is at or below 28 degrees Celsius.

34. The downhole tool of claim 27, wherein the pressure is greater than 10 GPa.

35. The downhole tool of claim 32, wherein the pressure is greater than 15 GPa.

36. The downhole tool of claim 32, wherein the pressure is greater than 20 GPa.

37. The downhole tool of claim 20, wherein the pressure is greater than 10 GPa and the temperature is at or below 28 degrees Celsius.

38. A wear layer for a wear element of a downhole tool, the wear layer comprising one or more superhard carbon allotropes, the wear layer having a size and dimension adapted for attachment to a substrate of the wear element.

39. The wear lawyer of claim 38, wherein the wear layer is consists essentially of the one or more superhard carbon allotropes, without metal binder or catalyst.

40. The wear layer of claim 38, wherein the wear element is a cutter for an earth cutting tool.
